(19) United States
(12) Patent Application Publication
(10) Pub. No.: US 2009/0017880 A1
(43) Pub. Date: Jan. 15, 2009

(54) ELECTRONIC LEVEL APPLICATION FOR PORTABLE COMMUNICATION DEVICE

(76) Inventors: Joseph Kyle Moore, Apex, NC (US); Gerard James Hayes, Wake Forest, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/777,507

(22) Filed: Jul. 13, 2007

(51) Int. Cl. H04M 1/00

(52) U.S. Cl. 455/575.1

(57) ABSTRACT

A portable communication device is equipped with a level application to provide the device with a level sensing functionality. The level application and level sensing functionality is based on data related to the orientation and/or motion of the device. The level application and level sensing functionality allow the position of the communication device in multidimensional space to be ascertained relative to a reference plane, which allows a user to utilize the communication device as a level.

### TECHNICAL FIELD OF THE INVENTION

The present invention relates to portable communication devices and, more particularly, to a portable communication device having a level application and level sensing functionality.

### DESCRIPTION OF THE RELATED ART

Electronic and laser levels are known and available in the market place. Such devices may provide features that may not be available with conventional spirit or bubble levels such as compactness or accuracy associated with electronic devices. While levels may be a necessity for people in the building, construction, or design/decorating industries, the average person may have a relatively limited need for such equipment. For example, an average person may not need a level other than for personal decorating such as hanging and leveling pictures, shelves, or other decorative items. And that need may be relatively infrequent. Consequently, the average person may not want to expend money to acquire a level, whether it be a conventional spirit or bubble level or an electronic or laser level, which may be used relatively infrequently. Further, they may not wish to purchase an item that will take up storage space and/or take time to locate and access prior to use.

### SUMMARY

The present invention relates, in one aspect, to a portable communication device that includes a level application having level sensing functionality. The level application/level functionality is implemented in a manner that provides a readable display on a portable communication device to indicate whether, at a selected time, the device has a spatial orientation that is level relative to a reference orientation. The level application allows a user to use their portable communication device as a level.

According to one aspect of the invention, there is provided a portable communication device comprising a housing; a display device; an orientation sensor; at least one first functionality that is operable in response to an output of the orientation sensor; and a second functionality that provides the communication device with a level functionality, the level functionality being operable by a level application that comprises processing data produced by the orientation sensor into level output data representative of the spatial orientation of the electronic device relative to a reference plane, the level output data being converted to a display form and displayed on the display device.

According to another aspect of the invention, the orientation sensor comprises at least one motion sensor.

According to another aspect of the invention, the orientation sensor comprises at least one motion sensor that detects acceleration, velocity, direction, directional change, rotation, or combinations of two or more thereof.

According to another aspect of the invention, the orientation sensor comprises at least one accelerometer.

According to another aspect of the invention, the level output data is displayed as a numeric value.

According to another aspect of the invention, the level output data is displayed as a numeric value, and a numeric value of zero corresponds to the electronic device being oriented in a substantially level position relative to the reference plane.

According to another aspect of the invention, the level output data is processed displayed as a virtual image that represents the orientation of the electronic device relative to a horizontal plane.

According to another aspect of the invention, the level output data is displayed as a virtual image having the appearance of a bubble level.

According to another aspect of the invention, the housing comprises opposing sides, and at least a portion of one side of the housing utilized in conjunction with the level functionality exhibits a substantially straight edge.

According to another aspect of the invention, the portable communication device comprises a camera and/or video application.

According to another aspect of the invention, the portable communication devices comprises a camera or video function, and the display device displays both (i) an object viewed with the camera and/or video application, and (ii) the display form relating to the spatial orientation of the electronic device relative to the reference plane.

According to another aspect of the invention, the portable communication device comprises a camera and/or video application, and further comprises a reference template displayed on the display device, wherein the reference template appears in a portion of the display area in which an image obtained from the camera and/or video function is displayed. According to another aspect of the invention, the reference template comprises a virtual image. According to another aspect of the invention, the reference template comprises a horizontal line, a vertical line, or combinations thereof. According to another aspect of the invention, the reference template is a crosshair.

According to another aspect of the invention, the data produced by the orientation sensor is obtained during a low duty cycle. According to another aspect of the invention, the low duty cycle is a duty cycle of about 5 Hz or less.

According to another aspect of the invention, there is provided a method of providing a portable communication device with level sensing functionality, the method comprising providing a portable communication device with an orientation sensor and at least two functionalities operable in response to output data from the orientation sensor, at least one of the functionalities being a level sensing functionality; obtaining data from the orientation sensor; comparing the data from the orientation sensor to level reference data for that device transforming the data obtained from the orientation sensor into level output data that is related to the position of the communication device in multidimensional space relative to a reference plane; and displaying the level output data in a form suitable to express the position of the communication device in multidimensional space relative to a reference plane.

### BRIEF DESCRIPTION OF THE DRAWINGS

Aspects of the invention may be better understood with reference to the following drawings. The components of the drawings are not necessarily to scale, emphasis instead being placed upon clearly illustrating the principles of the present invention. Likewise, elements and features in one drawing may be combined with elements and features depicted in other drawings. Moreover, like reference numerals designate corresponding parts throughout the several views.

FIG. 1 is a schematic front view of a portable communication device, embodied as a mobile telephone, in accordance with an embodiment of the present invention.

FIG. 2 is a schematic block diagram of a number of exemplary, relevant operative portions of the mobile phone of FIG. 1.

FIG. 3 is a flow chart representing a method of employing a level application to provide a portable communication device with level functionality in accordance with one embodiment of the invention.

FIG. 4 is a flow chart representing a method of employing a level application to provide a portable communication device with level sensing functionality in accordance with another embodiment of the invention.

FIGS. 5a and 5b are schematic views illustrating the use of the level application/level sensing functionality of the mobile telephone of FIG. 1 to level a desired object.

FIGS. 6a and 6b are schematic illustrations of a portable communication device with level sensing functionality in which the level application/level sensing functionality output is depicted as a virtual figure on the display device.

FIG. 7 is a schematic front view of a portable communication device, embodied as a mobile telephone with a camera assembly, in accordance with an embodiment of the present invention.

### DETAILED DESCRIPTION OF EMBODIMENTS

The present invention will now be described with reference to the drawings, wherein like reference numerals are used to refer to like elements throughout.

The term “electronic communication device” or “portable communication device includes portable radio communication equipment. The term “portable radio communication equipment,” which herein after may also be referred to as a “mobile radio terminal,” “mobile phone,” “mobile device,” or “mobile terminal”, and the like, includes all equipment such as mobile telephones, pagers, communicators, electronic organizers, personal digital assistants (PDAs), smartphones, portable communication apparatus, or the like.

The term “level” may be used herein as any of a noun, adjective, and/or verb. “Level” may mean a condition in which an object is substantially parallel relative to a reference plane. “Level” may further be used to refer to a device for establishing a line substantially parallel to a reference plane. “Level” may also be used in the sense of bringing an object to a position substantially parallel to a reference plane, that is, to make an object level. In one embodiment, the term “level” encompasses a condition in which an object is parallel to a horizontal plane. In one embodiment, the term “level” also encompasses the term “plumb,” which refers to a condition in which an object is oriented straight up and down or substantially parallel to a vertical plane.

The term “level application” refers to a feature in which a portable communication device may be operated to exhibit “level functionality” or “level sensing functionality.” “Level functionality” or “level sensing functionality” refers to a mode or condition in which a portable communication device functions or operates as a level (in this sense, a device for establishing a line substantially parallel to a reference plane).

The term “reference plane” includes any plane relative to the ground as selected by the user. The term “reference plane” encompasses a horizontal plane, a vertical plane (i.e., a plane perpendicular the ground plane), and/or any plane disposed at an angle intermediate the horizontal or vertical plane.

The term “orientation sensor” or “position sensor” includes any device that is capable of providing data that may be related to an orientation or position of an electronic communication device in multidimensional space. The data produced by the “orientation sensor” need not be directly related to the position or orientation of the communication device, but may be may be any data that may be processed to correlate or represent a position or orientation of the device in multidimensional space.

In the present application, the invention is described primarily in the context of a mobile phone. However, it will be appreciated that the invention is not intended to be limited to a mobile phone and can be any type of electronic communication device.

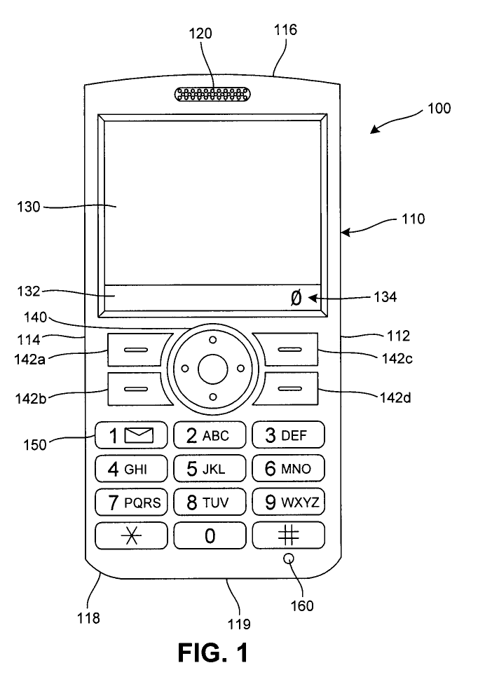

Referring now to FIG. 1, a mobile phone 100 is shown as having a “brick” or “block” design type housing 110, but it will be appreciated that other type housings, such as, for example, claim shell or slide-type housings, may be utilized without departing from the scope of the invention. The mobile phone 100 includes housing 110 (sometimes referred to as a case), speaker 120, display 130, navigation switch and selection/function keys or switches 140, 142a-d, key pad 150, microphone 160, and a volume control slide switch (not illustrated); these are illustrative and exemplary of parts of a typical mobile phone, but it will be appreciated that other parts that are similar or different in form and/or function may be included in the mobile phone 100. It will be appreciated that a mobile phone may be of the type that has more or fewer functions, keys, etc., compared to those illustrated and described herein.

As will be appreciated, the mobile phone 100 may function as a conventional mobile phone. The mobile phone 100 may have additional functions and capabilities that may be developed in the future. From a conventional point of view, the display 130 displays information to a user, such as operating state, time, phone numbers, contact information, various navigational menus, etc., which facilitate and/or enable the user to utilize the various features of the mobile phone. The display also may be used to view movies, images, or to play games, for example. In one embodiment, part or all of the display 130 may be a touch screen type device. The display device is not limited in any manner and may be provided by any suitable display technology including, but not limited to, a liquid crystal display (LCD), light emitting diodes (LED) panel, organic LED, or the like. It will be appreciated that the display screen 130 may be configured in any manner as desired for a particular purpose or intended use. For example, display screen 130 may permanently have one or more designated display areas such as display area 132 to represent particular functions. In another embodiment, display area 132 may be activated when certain applications functions, e.g., a level application or functionality in accordance with the present invention, are activated. In still another embodiment, the display screen need not include individual display areas.

The navigation and function keys 140, 142a-d and the keypad 150 may be conventional in that they provide for a variety of user operations. For example, one or more of the function keys and navigation device 140, 142a-d may be used to navigate through a menu displayed on the display 130 to select different phone functions, profiles, settings, etc., as is conventional. The keypad 150 typically includes one or more special function keys, such as, a “call send” key for initiating or answering a call, a “call end” key for ending or hanging up a call, and dialing keys for dialing a telephone number. Other keys included in the navigation and function keys 140 and/or keypad 150 may include an on/off power key, a web browser launch key, a camera key, a voice mail key, a calendar key, etc. The volume control switch may be operated to increase or to decrease the volume of the sound output from the speaker 120. If desired, a sensitivity control also may be provided to change the sensitivity of the microphone 160 as it picks up sounds for transmission by the mobile phone 100. The mobile phone 100 may have more of fewer keys, navigation devices, etc., compared to those illustrated.

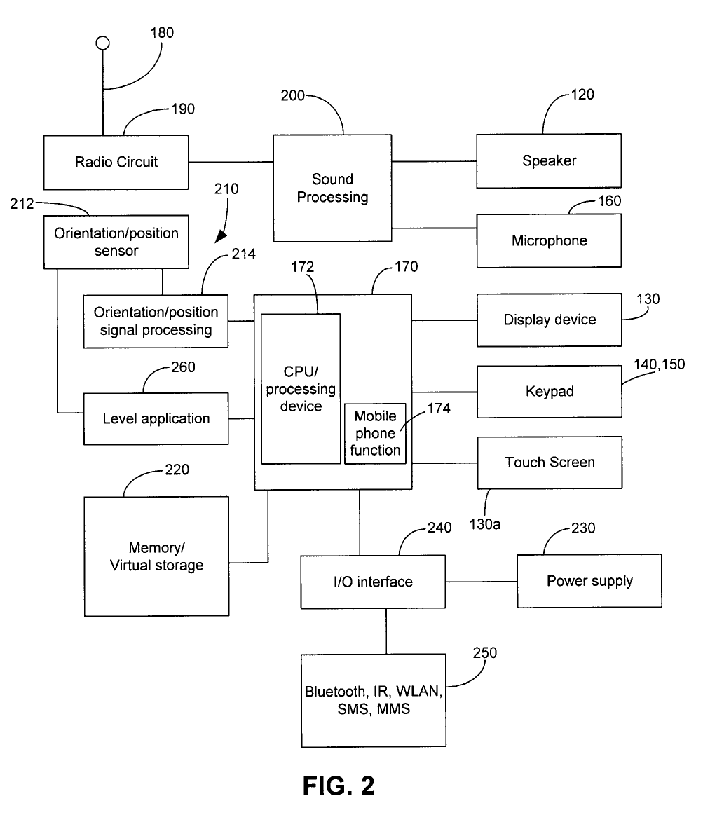

FIG. 2 represents a functional block diagram of an exemplary mobile phone, for example, the mobile phone 100. The representation also is similar to those of PDAs and/or other electronic equipment, as will be appreciated by those having ordinary skill in the art. The construction of the mobile phone 100, which is presented by way of example here, is generally conventional. The various functions carried out by the parts represented in the functional block diagram of FIG. 2 may be carried out by application software within the mobile phone 100. However, it will be apparent to those having ordinary skill in the art that such operation can be carried out via primarily software, hardware, firmware, or a combination thereof, without departing from the scope of the invention.

The mobile phone 100 includes a primary control circuit 170 that is configured to carry out overall control of the functions and operations of the mobile phone 100, e.g., as is represented at block 174. The control circuit 170 may include a CPU 172 (central processor unit), microcontroller, microprocessor, etc., collectively referred to herein simply as CPU 172. The CPU 172 executes code stored in memory (not shown) within the control circuit 170 and/or in a separate memory 220 in order to carry out conventional operation of the mobile phone functions within the mobile phone 100.

Continuing to refer to FIG. 2, the mobile phone 100 includes a conventional antenna 180, radio circuit 190, and sound processing signal circuit 200, all of which are cooperative to send and to receive radio frequency (or other) signals in conventional manner. For an incoming signal, for example, the sound processing signal circuit 200 may include an amplifier to amplify the signal and to provide it to the speaker 120 so a user may hear the sound, and the sound processing signal circuit 200 also may use the same amplifier or another amplifier to amplify signals from the microphone 160 for transmitting thereof via the radio circuit 190 and antenna 180 to another mobile telephone, to a cellular phone tower, to a satellite, etc. Operation of the radio circuit 190, sound processing signal circuit 200, speaker, and microphone, are under control of the control circuit 170, as is conventional.

The mobile phone 100 includes the display device 130, keypad 140, 150 (including the navigation device mentioned above), and optionally the capability of a touch screen 130a, which may be part or all of the display device 130, and these are coupled to the control circuit 170 for operation as is conventional.

As is illustrated in FIG. 2, the mobile phone 100 includes an input/output interface 240, a power supply 230, and a short distance communications mechanism 250, such as, for example a Bluetooth communications device, infrared (IR) communications device, or some other device. Another example of a short distance communications mechanism is wireless local area network (WLAN), and the invention also may use still other short distance communications mechanisms or devices that currently exist or may be developed in the future. The short distance communications mechanism 250 may transmit and receive signals using SMS (short message service), MMS (multimedia messaging service) or some other communications mechanism and protocol. Bluetooth, IR, WLAN communications for communicating over short distances between mobile phones are well known; other mechanisms may exist and/or may be developed in the future, and these may be utilized by and are included for use in the invention.

As illustrated in FIG. 2, the mobile phone 100 includes an orientation/position system 210. The orientation/position system may comprise an orientation/position sensor 212 that may be capable of providing a signal or data that may be related to the spatial orientation or position of the communication device. In one embodiment, the orientation/position sensor 212 may comprise an orientation or tilt sensor. In another embodiment, the orientation/position sensor may comprise a motion sensor, which may be any device, circuit or other mechanism or combination thereof, that provides an indication that motion has been sensed and/or provides an indication of the character of the motion, such as, for example, acceleration, velocity, direction, directional change, rotation, or any other characterization of the motion. In one embodiment, the motion sensor is an accelerometer that provides an output (e.g., electrical or some other output) in response to acceleration. Another example is a velocimeter that provides a signal representative of velocity. Still another example is a signal detector that responds to changes in electrical signals, radio frequency signals, or some other signals, such as amplitude or frequency or changes therein, Doppler shift, or some other discernable change that occurs due to motion.

The orientation/position sensor system 210 also includes an orientation/position signal processing circuit 214. The orientation/position sensor produces an output indicative of an orientation or position of the mobile phone. This output is provided to the processing circuit that processes and conditions the signal prior to being input to the control circuit. For example, in the case where the orientation sensor 212 comprises a motion sensor, such as an accelerometer, the motion sensor provides an output, and the processing circuit 214 provides a motion signal to the control circuit to indicate that at least one characteristic of that motion, e.g., acceleration, has been detected and/or that motion has been ceased.

A portable communication device in accordance with the present invention includes at least one first functionality that is operable in response to an output or signal produced by the orientation/position sensor. The at least one first functionality is not limited to a single functionality but may refer to two or more functionalities operable in response to an output produced by the orientation sensor. Examples of functionalities may include, but are not limited to, rotation/alteration of the orientation of a display in response to the change of rotation, acceleration, or other parameters of the device, menu navigation or selection via tilting, moving, or shaking a device, a hands-free push-to-talk function in response to movement of the device, or the like. It will be appreciated that the communication device would include application programs for using data from the orientation/position sensor to carryout a function. A person having ordinary skill in the art of computer programming and applications programming will be able to program a communication device to operate and carryout the desired function.

In one embodiment, the orientation sensor comprises a motion sensor such as, for example, an accelerometer. The accelerometer is generally not limited in any particular manner. In one embodiment, the accelerometer may be a 2-axis accelerometer. In another embodiment, the accelerometer may be a 3-axis accelerometer. Examples of suitable accelerometers include, but are not limited to, a Kionix® KXG accelerometer, an Analog Devices® ADXL05 accelerometer, a Motorola® MMA1260D accelerometer, and the like.

A portable communication device in accordance with the present invention also includes a level application that may be employed to provide the device with a level functionality or level sensing functionality. Referring to FIG. 2, the communication device 100 includes level application 260. The level application is coupled to the orientation position system 210. In particular, the level application 260 may be coupled to the orientation sensor 212. The level application 260 may use data produced by the orientation sensor to provide the communication device with a level functionality.

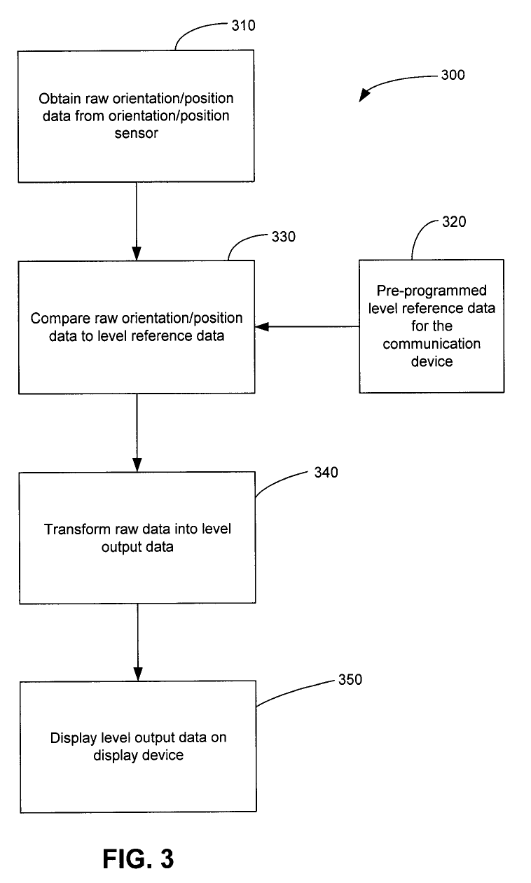

FIG. 3 illustrates an embodiment of a method utilizing the level application 260 to provide a portable communication device with level sensing functionality. As shown in FIG. 3, method 300 begins at functional box 310 by sampling raw data from an orientation/position sensor such as, for example, sensor 212. As shown in functional box 320, the communication device contains pre-programmed reference data (which may also be referred to herein as “level reference data”) that corresponds or relates to the orientation of the device in multidimensional space relative to the selected reference plane. The communication device is calibrated to obtain the level reference data. The communication device may be calibrated by selecting an orientation of the communication device as representing a level position relative to a reference plane and obtaining output data from the orientation sensor, which becomes the level reference data for that orientation. The level reference data may be assigned a value that provides a meaningful or useful representation of the orientation of the communication device in multidimensional space relative to the reference plane. One or more positions that deviate from a level position may be calibrated by moving the device to a selected position, obtaining the data from the orientation sensor for that position, assigning values to the data, and programming the device to recognize the output at that selected position as corresponding to the assigned value. The level reference data and the assigned value for the respective data points are pre-programmed into the communication device.

The assigned values may be selected as desired to represent the output data from the orientation sensor as any useful or meaningful value. For example, the assigned values may represent the level reference data as a percentage relative to level, a degree, or the like. In one embodiment, the output from the orientation sensor may be programmed to represent a percentage relative to level; for example, a value of 100% may represent a level position, and values less than 100% may represent how close to level the device is oriented (e.g., a value of 90% may represent that the device is 90% level). In another embodiment, the output may be programmed to represent the percentage of deviation from level. In this embodiment, a value of zero (0) may indicate a level position (i.e., 0% deviation), a value of 10% may indicate that the device deviates from level by an amount of 10%, and so forth. In another embodiment, the calibrated reference data may represent an angle value in degrees (or other selected unit). The particular scale, precision, and/or sensitivity of the scale may be selected as desired by the manufacturer for a particular purpose or intended use.

With reference back to FIG. 3 then, at functional box 330, the data sampled from the orientation sensor is compared to the level reference data for the device. At functional box 340, based on the comparison of the raw data to the reference data, the raw data is then transformed into output level data representative of the position of the device in multidimensional space relative to the reference plane. For example, the communication device may contain an algorithm or program to compare the raw data to the level reference data and convert the raw data to an appropriate output. By comparing the raw data to the level reference data and the assigned value for the level reference data, the raw data can be assigned a value that relates to the position of the device relative to a reference plane. This value for the raw data may be referred to as the level output data. At functional box 350, the level output data is processed into a display format and displayed on the display device of the communication device.

For example, in one embodiment, the orientation sensor may comprise an accelerometer. The accelerometer may produce data when the phone is in a static state that may be related to the position of the phones in space (e.g., its position in the X plane and the Y plane in a 2-axis accelerometer, or in the X, Y, and Z planes in a 3-axis accelerometer). The communication device may be calibrated by placing the device in a position level to a reference plane, obtaining the output from the accelerometer, which becomes the level reference data for the device in that position, and assigning a value to that level reference data. The same process would be followed to calibrate other non-level positions. The level reference data may be pre-programmed to represent a value such as, for example, zero for the level reference data corresponding to a level position. When the communication device is in level sensing mode, a user would move the device to a particular orientation and the device would obtain raw data from the accelerometer, compare the new data to the level reference data, and transform the data to an appropriate level out put data, which would be displayed on the display device.

The level reference data obtained from an orientation sensor may depend on the position, location, and/or orientation of the orientation sensor on the circuit board of the communication device. It will be appreciated that the level reference data and assigned values for the reference data may be programmed into and applied to similar models of communication devices having similar mechanics and/or a similar circuit board layout. That is, it may not be necessary to individually calibrate all communication devices of a particular model.

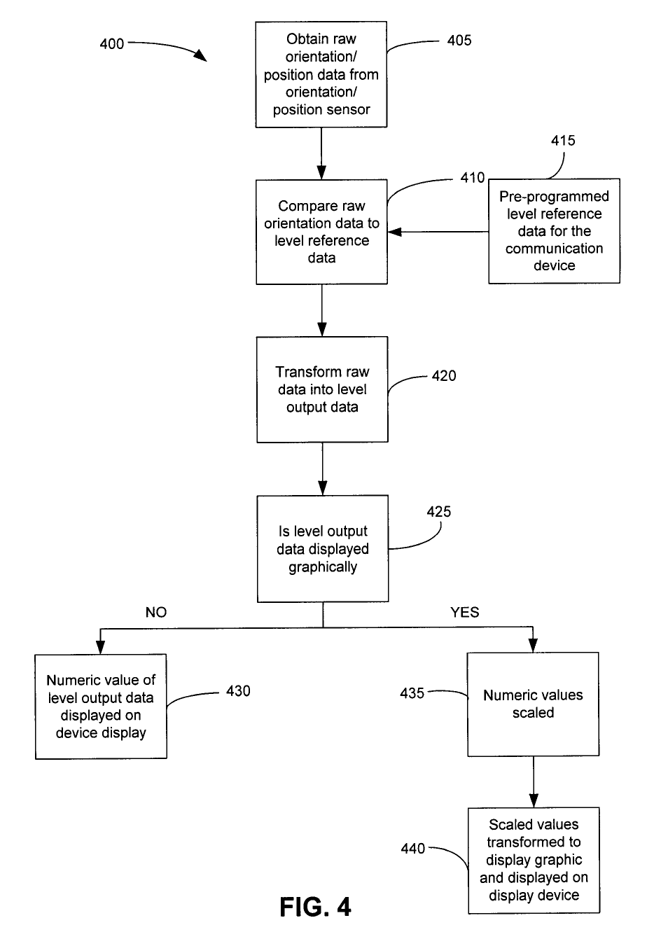

The level output data may be presented in numerical form, graphical form, or both numerical and graphical form. FIG. 4 illustrates another embodiment of the disclosed method in connection with the level sensing application or functionality. The method 400 begins at functional box 405 gathering the raw data from the orientation sensor. As functional box 410, the raw data is compared to reference data (from functional box 415). At functional box 420, the raw data is transformed into level output data. At functional box 420, the application evaluates whether the data is to be displayed graphically. If the data is not to be displayed graphically, the application proceeds to functional box 430, and the level output data is processed to a display format and displayed as a numeric value. If the data is to be displayed graphically, the application proceeds to functional box 435 and the numeric values are scaled (if necessary). At functional box 440, the scaled values are processed or converted into a graphic to represent the orientation of the device in multidimensional space relative to a reference plane. The scaled values may be displayed to represent every angle of the communication device relative to the reference plane.

A person having ordinary skill in the art of computer programming, and specifically in applications programming for mobile phones, will, in view of the provided description, be able to program a mobile phone to operate and carry out the functions described herein with respect to the level application 260 and methods of carrying out the level application (e.g., methods 300 and/or 400) and any interfacing between the level application 260 and other application programs (e.g., messaging application programs, such as a universal messenger program, media application programs and the like). Accordingly, details as to the specific programming code have been left out. Also, while the level sensing functionality may be carried out via the controller 170 and level application 260 (alone or in conjunction with other application programs) in memory in accordance with inventive aspects, such function also could be carried out via dedicated hardware, firmware, software, or combinations thereof without departing from the scope of the present invention.

To obtain the data to provide the communication device with level functionality, the raw data may be sampled from the orientation at any desirable time during operation of the device. In one embodiment, the orientation sensor may be sampled during low duty cycles of the communication device. As used herein, a low duty cycle refers to a duty cycle of about 5 Hz or less. In one embodiment, the orientation sensor is sampled in a duty cycle of about 2 Hz or less, and in another embodiment in a duty cycle of about 1 Hz or less.

In one embodiment, the portable communication device may be programmed such that the level application is set or programmed to run on a substantially continuous basis. In another embodiment, the portable communication device may be programmed such that the level application may be selectively activated and deactivated by the user.

When the level output data is represented in numerical form, any scale or standard may be selected to represent the orientation of the device in multidimensional space relative to a reference plane. For example, in one embodiment, a value of zero (0) may be selected to correspond to a condition in which the communication device is level relative to the reference plane, and positive and negative values (i.e., values greater than or less than zero, respectively) may be selected to indicate that the communication device is angled in a particular direction relative to the reference plane. The numeric values may represent the magnitude of deviation from a level position. In one embodiment, the numeric values may correspond to the angle (in degrees) at which the device is deviated from a level position.

As an example, in one embodiment, the level application may be used to determine whether an object is level relative to a true horizontal position. The numeric value of zero (0) may be selected to correspond to a true horizontal position, and positive values and negative values may be selected to correspond to the device being tilted in a particular direction relative to a true horizontal position. In one embodiment, a value of zero (0) may be selected to correspond to a true horizontal position, and the numeric values may represent the angle of tilt (e.g. a 10° angle of tilt relative to a true horizontal plane). For example, as shown in FIG. 1, the display screen 130 may include a display area 132 that includes display item 134, which is depicted as a numeric value (zero in this case) indicating the orientation of the communication device 100 in multidimensional space relative to a reference plane.

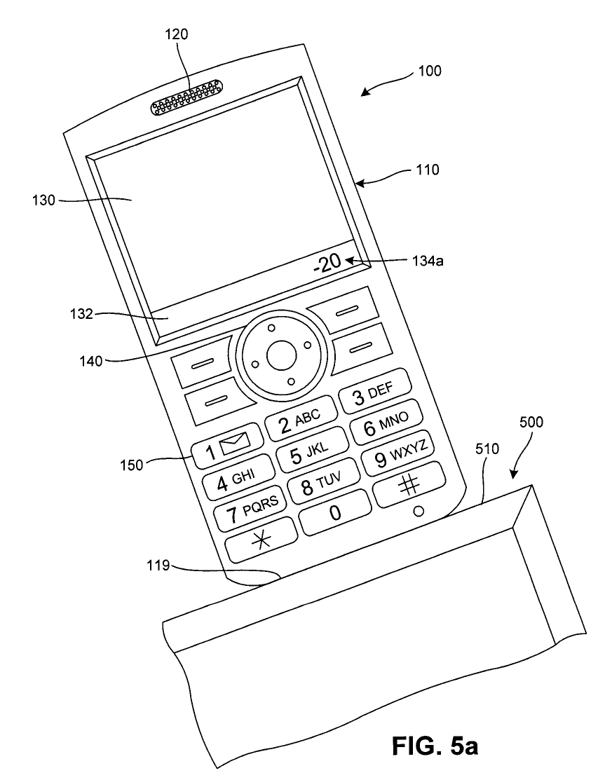

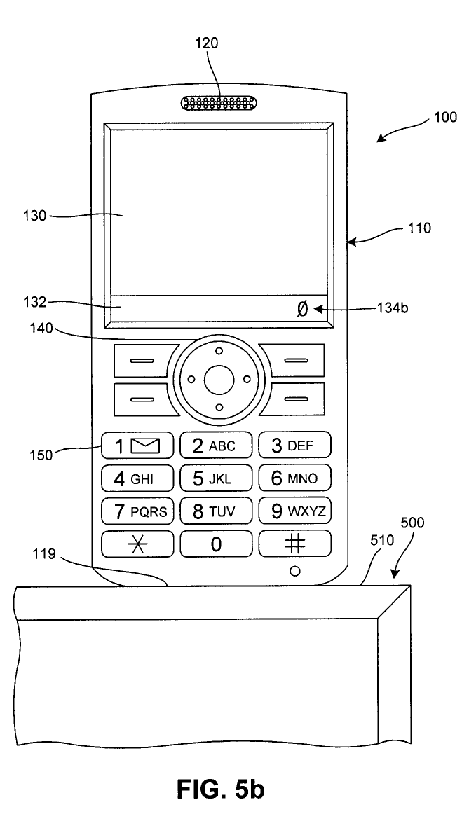

FIGS. 5a and 5b illustrate the way in which the level application or functionality may be used. For example, the level application may be used to provide the portable communication device 100 with level sensing functionality to enable a user to evaluate whether an object, such as, for example, a picture frame 500 is level; this functionality may allow the user to subsequently level the object. As shown in FIG. 5a, edge 119 of communication device 100 is placed along edge 510 of picture frame 500. Using the level application, the orientation of the device 100 is ascertained as described above, and the orientation of the device in multidimensional space relative to a reference plane (e.g., the horizontal plane in this case) is determined as described above. As shown in FIG. 5a, the object 500 is not level relative to horizontal, and the display screen 130 on the communication device displays display item 134a, depicted as a numeric value of −20. A user may then move or reposition the object as desired and obtain another reading to determine if the object is level relative to the desired reference plane. As shown in FIG. 5b, the object 500 has been repositioned and the orientation of the communication device in multidimensional space has been determined. In FIG. 5b, the orientation relative to horizontal has been evaluated and is displayed as numeric display item 134b, which is shown as having a value of zero thereby indicating that the communication device and the object upon which it is resting are level relative to horizontal.

As illustrated in the above example, to use the level functionality, it may be desirable to place the communication device in physical contact with the object of interest. Thus, in one embodiment, it may be desirable to provide at least a portion of the housing with a substantially straight edge to assist the user in maintaining the communication device in a relatively stable position when the communication device is in contact with the object of interest. For example, with reference to FIG. 1 and FIGS. 5a and 5b, the bottom edge 118 of the housing 110 may include a portion 119 having a substantially straight edge. Straight edge portion 119 may be placed in contact with the edge of object (e.g., edge 510 or object 500) to obtain level readings.

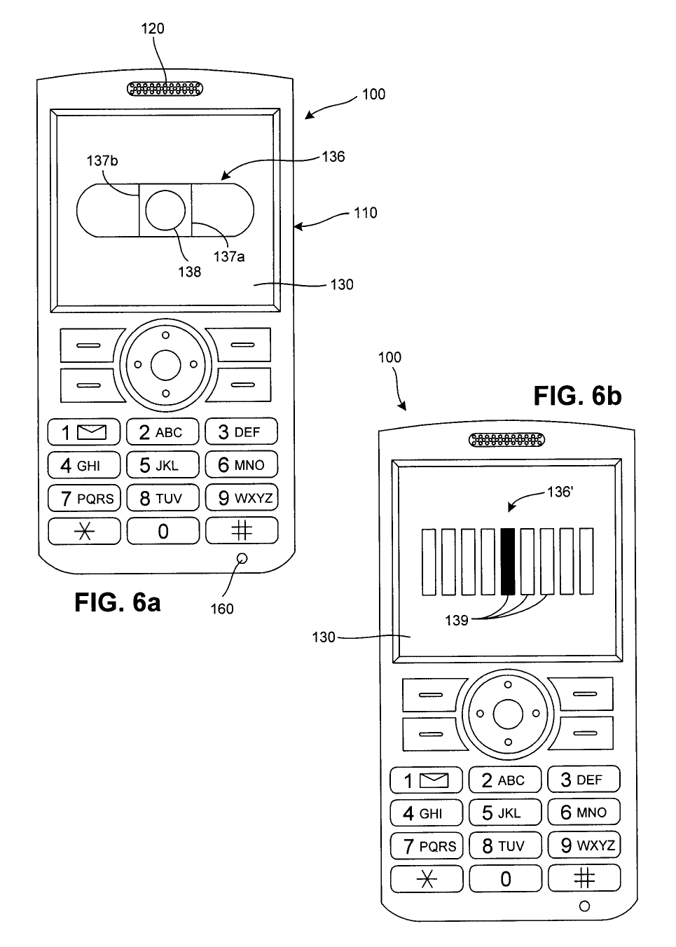

As described above, the level output data may also be represented or displayed as a graphical form or image. The form, shape, or figure, of the graphical form may be selected as desired to sufficiently represent the spatial orientation of the communication device in multidimensional space relative to a reference plane. FIGS. 6a and 6b illustrate embodiments of graphical forms that may be used to illustrate the orientation of the communication device in multidimensional space relative to a reference plane. In FIG. 6a, the level output data is represented as graphical form or display image 136, which is depicted as a virtual bubble level. The display image 136 includes a virtual bubble 138 and position markers 137a and 137b. Similar to using and reading a conventional spirit or bubble level, the communication device (or object upon which the communication device is placed) is level when the virtual bubble is positioned between markers 137a and 137b.

In FIG. 6b, the display 136′ comprises a series of bars 139 to represent the level output data. The center bar corresponds to a level position relative to the selected reference plane. In one embodiment, the reading or read-out corresponding to the position of the device in multidimensional space relative to the reference plane may be indicated by a filled bar. In another embodiment, the read-out may be indicated by a non-filled bar. As shown in FIG. 6b, the displayed position data is indicated by a filled bar. As shown, in FIG. 6b, the center bar is filled, which, in this embodiment, represents that the communication is oriented in a position that is level relative to the reference plane. If the bars to the left or right of the center bar were filled (or partially filled), this would indicate that the communication device is not oriented in a position that is level relative to the reference plane.

The displays in FIGS. 6a and 6b are merely illustrative examples of possible graphic displays to represent the orientation of the communication device. Other non-limiting examples of suitable graphic displays for the level functionality include a virtual bulls-eye bubble level (i.e., a circle in which an item is considered level if a virtual bubble is located with the circle), or a line that rotates to reflect the orientation of the device.

It will be appreciated that, in one embodiment, the orientation of the device could be displayed both numerically and graphically. For example, in addition to a graphic image such as those in FIG. 6a or 6b, the display screen 130 could also include a numeric value as a compliment to the graphical display of the orientation.

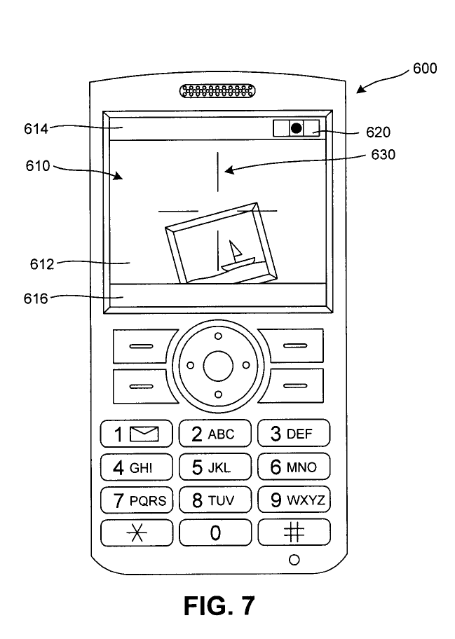

In one embodiment, a communication device comprising camera and/or video functions may also comprise a level application. With reference to FIG. 7, a camera phone 600 is shown. Camera phone 600 is similar to mobile phone 100 of FIGS. 1, 5a, 5b, 6a, and/or 6b, with the exception that camera phone 600 includes a camera assembly on the rear of the phone (not illustrated). Camera assemblies for mobile telephones are known and include, for example, a sensor, imaging optics, and a camera controller. Assemblies may also include a light meter and a flash. The camera phone also includes logic and software applications (not illustrated) to operate the phone.

In one embodiment, the level application of a communication device comprising camera and/or video functions may be used independently of the camera or video functions. In such an embodiment, the level application may be used as described above to provide the communication device with level functionality and allow a user to level an object by contacting the communication device with the object of interest and evaluating the display to determine if the object is level relative to a selected reference plane.

In another embodiment, the camera or video function may be employed in conjunction with the level application. For example, as shown in FIG. 7, camera phone 600 is operated in camera/video mode to view an object 700 through the display area 612 of display screen 610. In FIG. 7, the display area 612 is framed between display areas 614 and 616, which may be used to display other information related to functions of the phone 600. The orientation of the object 700 may be evaluated by employing the level application and level sensing functionality. As shown in FIG. 7, the level application has been activated, and information regarding the orientation of the phone 600 is displayed via display graphic 612, which appears in display area 614. As shown in FIG. 7, display graphic 612 is a virtual bubble and depicts the camera phone 600 as being level (in this case, level relative to horizontal). Using the information from the level application, the user may be able to visually assess whether the object being viewed is in the desired position (e.g., level or plumb relative to a desired reference plane). The user may then instruct another person to move the object in a particular direction to achieve a desired position or move the object themselves and reevaluate whether the object is level using the level application of the device.

While the user may be able to visually assess whether the object being viewed is level, it may be desirable to provide a reference template for the user to evaluate the position of the object. In one embodiment, for example, the user may be able to use the edges of the display screen or the frame created by other display areas (e.g., the edges of display areas 614 and 616 in FIG. 7) as a reference point to compare whether the object being viewed is level. Presumably, these edges would be straight, and if the communication device is being held in a level position relative to a particular reference plane, the user can determine if the object being viewed is also level.

In another embodiment, the communication device may include a display function in which a reference template or grid may be displayed during operation of the camera/video function. As shown in FIG. 7, display area 612 also includes a reference template that appears as display image 630, which is illustrated as crosshairs. In FIG. 7, camera phone 600 is depicted as being level, and using crosshairs 630, a user would be able to access that object 700 is not level. The user may instruct another person to move object 700 until it is oriented such that one or more edges of the object lie in the plane of or is parallel to the horizontal and/or parallel lines of the crosshairs. It will be appreciated that the reference template may be any form such as, for example, a straight horizontal line, a straight vertical line, combinations of straight horizontal and vertical lines, angled lines, a grid of vertical and horizontal lines, or a grid of angled lines. The reference template may be a temporary graphic that can be activated or deactivated, or may be a permanent image on the display screen.

Additionally, the control circuit and/or CPU may be provided with control logic to allow the user to select the reference plane. Thus, while the embodiments described above illustrate the phone 100 or 600 being level relative to horizontal when in the upright position, the phone may be provided or programmed with logic functions to enable the user to select the upright position as being level (or plumb) relative to vertical. Additionally, in one embodiment, the level application may be programmed to detect the position of the communication device relative to two or more reference planes, e.g., both horizontal and vertical. In such an embodiment, the display output may be configured to display the two or more level output results. In another embodiment, the communication device may be provided with logic such that the selected or desired reference plane is recognized or maintained if the screen display is switched from a portrait (upright) mode to a landscape mode and/or if the device is held in an upright or sideways position.

Although the invention has been shown and described with reference to certain exemplary embodiments, it is understood that equivalents and modifications may occur to others skilled in the art upon reading and understanding the specification. The present invention is intended to include all such equivalents and modifications as they come within the scope of the following claims.

1. A portable communication device comprising:
a housing;
a display device;
an orientation sensor;
at least one first functionality that is operable in response to an output of the orientation sensor; and
a second functionality that provides the communication device with a level functionality, the level functionality being operable by a level application that comprises processing data produced by the orientation sensor into level output data representative of the spatial orientation of the electronic device relative to a reference plane, the level output data being converted to a display form and displayed on the display device.

2. The portable communication device according to claim 1, wherein the orientation sensor comprises at least one motion sensor.

3. The portable communication device according to claim 2, wherein the at least one motion sensor detects acceleration, velocity, direction, directional change, rotation, or combinations of two or more thereof.

4. The portable communication device according to claim 2, wherein the orientation sensor comprises at least one accelerometer.

5. The portable communication device according to claim 1, wherein the level output data is displayed as a numeric value.

6. The portable communication device according to claim 5, wherein a numeric value of zero corresponds to the electronic device being oriented in a substantially level position relative to the reference plane.

7. The portable communication device according to claim 1, wherein the level output data is processed and displayed as a virtual image that represents the orientation of the electronic device relative to the reference plane.

8. The portable communication device according to claim 7, wherein the virtual image has the appearance of a bubble level.

9. The electronic communication according to claim 1, wherein the housing comprises opposing sides, and at least a portion of one side of the housing utilized in conjunction with the level functionality exhibits a substantially straight edge.

10. The portable communication device according to claim 1, further comprising a camera and/or video application.

11. The portable communication device according to claim 10, wherein the display device displays both (i) an object viewed with the camera and/or video application, and (ii) the display form relating to the spatial orientation of the electronic device relative to the reference plane.

12. The portable communication device according to claim 11, further comprising a reference template displayed on the display device, wherein the reference template appears in a portion of the display area in which an image obtained from the camera and/or video function is displayed.

13. The portable communication device according to claim 12, wherein the reference template comprises a virtual image.

14. The portable communication device according to claim 12, wherein the reference template comprises a horizontal line, a vertical line, or combinations thereof.

15. The portable communication device according to claim 12, wherein the reference template is a crosshair.

16. The portable communication device according to claim 1, wherein the data produced by the orientation sensor is obtained during a low duty cycle.

17. The portable communication device according to claim 1, wherein the low duty cycle is a duty cycle of about 5 Hz or less.

18. A method of providing a portable communication device with level sensing functionality, the method comprising:
providing a portable communication device with an orientation sensor and at least two functionalities operable in response to output data from the orientation sensor, at least one of the functionalities being a level sensing functionality;
obtaining data from the orientation sensor;
comparing the data from the orientation sensor to level reference data for that device;
transforming the data obtained from the orientation sensor into level output data that is related to the position of the communication device in multidimensional space relative to a reference plane; and
displaying the data in a form suitable to express the position of the communication device in multidimensional space relative to a reference plane.

19. The method according to claim 18, wherein the orientation sensor comprises at least one motion sensor.

20. The method according to claim 18, wherein the orientation sensor comprises at least one accelerometer.

21. The method according to claim 18, wherein the data from the orientation sensor is obtained during a low duty cycle.

22. The method according to claim 21, wherein the low duty cycle is a duty cycle of about 5 Hz or less.

23. The method according to claim 18, wherein the level output data is displayed as a numeric value.

24. The method according to claim 18, wherein the level output data is displayed as a graphic image.
